(19) United States
(12) Patent Application Publication
(10) Pub. No.: US 2015/0200829 A1
(43) Pub. Date: Jul. 16, 2015

(54) TASK-BASED STATE RECOVERY IN A WEB BROWSER

(71) Applicant: Google Inc., Mountain View, CA (US)

(72) Inventors: Patrick Louis Dubroy, Munich (DE); Patrick Louis Maurice Nepper, Rosenheim (DE); Bryan Christopher Horling, Sunnyvale, CA (US)

(21) Appl. No.: 13/831,523

(22) Filed: Mar. 14, 2013

(51) Int. Cl. H04L 12/26

(52) U.S. Cl. CPC H04L 43/0876

(57) ABSTRACT

A method includes identifying one or more browsing sessions from a plurality of browsing activities, each of the one or more browsing sessions comprising browsing activities having a common theme, identifying a browser state of each of the one or more browsing sessions, generating a record representing the browser state of each of the one or more browsing sessions, wherein the record is associated with the common theme of the browsing activities comprising each of the one or more browsing sessions, storing the generated record representing the browser state of each of the one or more browsing sessions and retrieving the stored record when a current online activity has a theme that corresponds to the common theme of the at least one of the one or more browsing sessions.

### BACKGROUND

Complex information gathering tasks may take days or even weeks. As a user browses the internet for relevant information, the user builds up a browser state which includes data pertaining to the different windows and tabs the user may have opened to view information that pertains to his or her research. When the information gathering task is interrupted, for example, as when the user closes the browser or switches devices, the particular browser state is lost.

### SUMMARY

The subject disclosure relates generally to data management, and more particularly to recovering a browser state.

The subject disclosure relates to a computer-implemented method that includes identifying one or more browsing sessions from a plurality of browsing activities, each of the one or more browsing sessions comprising browsing activities having a common theme, identifying a browser state of each of the one or more browsing sessions, generating a record representing the browser state of each of the one or more browsing sessions, wherein the record is associated with the common theme of the browsing activities comprising each of the one or more browsing sessions, storing the generated record representing the browser state of each of the one or more browsing sessions and retrieving the stored record when a current online activity has a theme that corresponds to the common theme of the at least one of the one or more browsing sessions.

The subject disclosure also relates to a system that includes a browsing session identification module configured to identify a browsing session from a plurality of browsing activities, wherein the browsing session comprises browsing activities having a common theme, a browser state module configured to identify a browser state of the identified browsing session, a records module configured to generate a record representing the browser state of the browsing session, wherein the record is associated with the common theme of the browsing activities comprising the browsing session, and a provisioning module configured to retrieve the stored record when a current online activity has a theme that corresponds to the common theme of the browsing session.

The subject disclosure furthermore relates to a machine-readable medium comprising instructions stored therein, which when executed by the processors, cause the processors to perform operations that include identifying a plurality of browsing activities, identifying a theme for each identified browsing activity, determining a theme that is common to at least two of the identified browsing activities, grouping the at least two browsing activities having the common theme into a browsing session, identifying a browser state of the browsing session, generating a record representing the browser state of the browsing session, wherein the record is associated with the common theme of the browsing activities comprising the browsing session, identifying a current online activity, wherein the current online activity occurs subsequent to the plurality of browsing activities comprising the browsing session based on which the record representing the browser state of the browsing session is generated, identifying a theme for the current online activity, comparing the identified theme of the current online activity to the common theme of the browsing session, retrieving the stored record when a current online activity has a theme that corresponds to the common theme of the browsing session and providing the generated record to a user associated with the current online activity.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 is a diagram of an exemplary system for recovering a browser state.

FIG. 2 illustrates a flow diagram of an example process for recovering a browser state.

FIGS. 3A and 3B illustrate an example browser in which a browser state associated with a browsing session is recovered.

FIG. 4 conceptually illustrates an example of a system for recovering a browser state.

FIG. 5 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, that the implementations of the present disclosure may be practiced without some of these specific details. In other instances, structures and techniques have not been shown in detail so as not to obscure the disclosure.

Methods and systems for recovering a browser state are provided herein. As a user browses the internet, a snapshot of a browser state associated with a browsing session is created and stored locally, at a client device, or at a remote server. The browser state may include data pertaining to the various browser windows that are open, the web pages displayed in browser windows, scrolling position, window position, and the like. The browser state may also include data pertaining to the different windows and tabs the user may have opened to view information that pertains to his or her research, as well as which users or accounts are currently active, hosts and web sites being visited, the device currently being used, and the time of day.

A particular browser state may be designated by the user and a snapshot or, more generally, a record may be created at the user's request, when the user indicates that a particular browser state should be saved. Alternatively, snapshots may be created automatically by the system. For example, a run-time process may determine how to segment a user's browsing history into discrete tasks and identify a browsing session, represented by a discrete browser state. A browsing session may be characterized by browsing activities that relate to a common theme. According to one aspect, at least two browsing activities related to a common theme may be required to constitute a browsing session. For example, at least two online activities related to searching about “Paris” (e.g., a two tabs opened from a common search) may be deemed a browsing session. Automatic segmentation of the browsing history may be done using the web pages that are seen (e.g., content, link structure, host name, etc.), the user's timeline, search terms entered at the browser, or other similar features. A user's activity across other devices may also be incorporated.

A snapshot or a record of a browser state may be created while the browser state is open. Alternatively, a stream of the user's browsing activity may be stored and snapshots may be built based on the content of the stream. The snapshots may also be named, manually by the user, or automatically, based on the content of the snapshot. Naming a snapshot may include associating an image such as a screenshot of the state, with the snapshot.

Determining when to retrieve a snapshot may include receiving an express instruction from the user to restore a browser state snapshot. For example, a list of all available snapshots may be provided for the user's selection and the user may pick one. Alternatively, the system may automatically determine, based on the user's current browsing activity, whether a similar browser state snapshot is available. To that end, the system may compare the user's current activity to the historic snapshots and decide whether the current activity matches one of the saved snapshots. Such comparison may be done by considering the search terms entered at the browser, the content of the web pages that are viewed by the user, the hosts or websites that are visited, the device currently used, the time of day, etc. When a potential match is found, the matching snapshot may be retrieved and presented to the user, giving the user an opportunity to restore the browser state captured by the snapshot. Alternatively, the user may merge the browser state captured by the snapshot with the current state. The matching snapshot may be presented to the user in the browser, when the user opens a new tab, on the search results page, or the like.

In addition to restoring a snapshot, the system may combine elements of different snapshots or remove elements that do not belong. For example, if a user researching the topic “Paris” looked at several different hotels, the several different hotels may be included in the snapshot. This may be done by, for example, appending the tabs representing the browser windows including the several different hotels to each other, or by creating a new browser tab containing all of the different information. Similarly, if there is information that appears inapposite to the research about “Paris,” such information may be removed from the snapshot. For example, if the user had his or her email application open concurrently with researching “Paris” the system may deem the email tab irrelevant and remove it prior to restoring the snapshot. Information may be deemed to belong to a different task due to system-made inferences based on content, access patterns or other features.

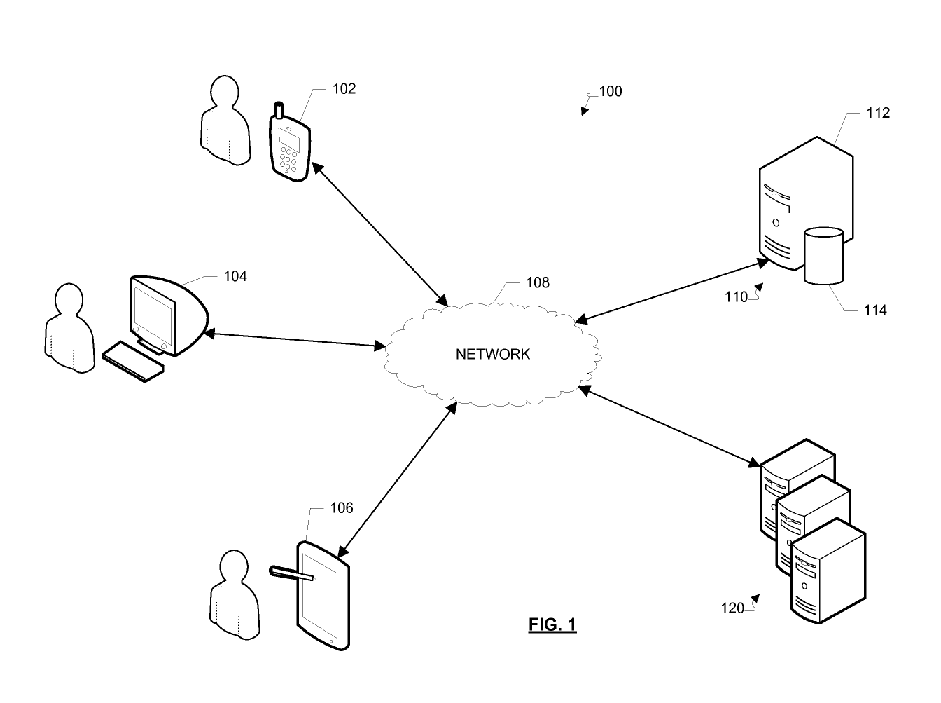

FIG. 1 illustrates an example client-server network that provides for recovering a browser state. A network 100 includes a number of electronic devices 102, 104 and 106 communicably connected to a server 110 by a network 108. Server 110 includes a processing device 112 and a data store 114. Processing device 112 executes computer instructions stored in data store 114, for example, instructions to identify a browsing session from a plurality of browsing activities, determine a browser state of the browsing session, generate a record representing the browser state, retrieve the stored record and provide the generated record to a client device or a user associated with a current online activity having a theme that corresponds to the common theme of the browsing session.

Data store 114 may store the generated record as well as data relating to various browsing activities or browsing sessions. Server 110 or application servers 120 may host an application within which some of the processes discussed herein are implemented. For example, server 110 or application servers 120 may determine whether current online activity has a theme that corresponds to the theme of the browsing session. The server 110 or application servers 120 may cause the generated record to be provided to a user when the system determines that a current online activity has a theme that corresponds to the common theme of the browsing session. According to one aspect, the generated record represents a browser state that may be created while the browser state is open. Alternatively, a stream of the user's browsing activity may be stored and snapshots may be built based on the content of the stream.

In some example aspects, electronic devices or client devices, as used interchangeably herein, 102, 104 and 106 can be computing devices such as smartphones, PDAs, portable media players, tablet computers, televisions or other displays with one or more processors coupled thereto or embedded therein, or other appropriate computing devices that can be used for conducting a browsing session.

Electronic devices 102, 104, 106 may have one or more processors embedded therein or attached thereto, or other appropriate computing devices that can be used for accessing a host, such as server 110. In the example of FIG. 1, electronic device 102 is depicted as a smartphone, electronic device 104 is depicted as a computer, and electronic device 106 is depicted as a PDA. A client is an application or a system that accesses a service made available by a server that is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

The system (e.g., hosted at server 110) recovers a browsing state associated with a browsing session when similar online activity or a search query having a theme that is similar to the theme of the browsing session is detected. To that end, the system identifies browsing activities and analyzes them to determine whether two or more browsing activities have a common theme and thus belong to the same browsing session. A browser state of the browsing session is identified and stored as a record. The record is provided, i.e., the browser state is recovered, when current online activity having a corresponding theme or a search query having a corresponding theme is identified. The record may be provided instead of or in addition to executing the received search query. The record may be merged with the search results or appended thereto. A user may interact with the system with any of the electronic device 102, 104, 106.

Application servers 120 are in communication with the electronic devices 102-106 through network 108. Each electronic device 102, 104, 106 may be a client device or a host device. In some example aspects, server 110 can be a single computing device such as a computer server. In other implementations, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like. According to an aspect of the disclosed technology, some or all of the processes disclosed herein may be performed without a network. For example, the operations may be performed locally on a client device.

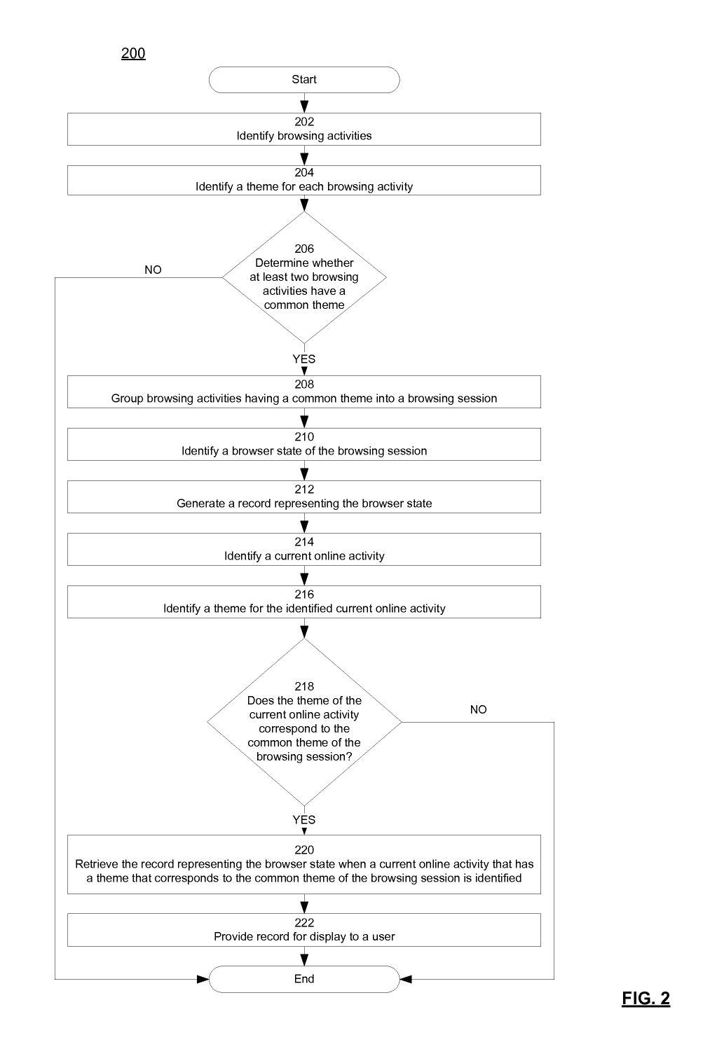

FIG. 2 illustrates a flow diagram of an example process 200 for recovering a browser state. The process starts and at block 202, browsing activities are identified. According to an aspect of the disclosed technology, identifying browsing activities may be a user-driven process, where a user causes the system to identify the browsing activities for the purpose of saving and later recovering a browser state associated with a browsing session. For example, a user may select a “save browser state” option from a menu or click a button on a graphic user interface for saving his or her research activity. Thus, detecting a browsing session or saving a browser state may be user-controlled by a setting.

According to another aspect of the disclosed technology an automatic, run-time process may cause the process 200 to take place. The run-time process may learn how best to segment browsing activities into browsing sessions for the purpose of saving and later recovering a browser state associated with a browsing session. The process 200 may also be done off line. Process 200 may be accomplished locally, on a client device or on a remote server with sufficient access to relevant data. A user's search history and activity across other client devices may also be utilized by process 200.

Browsing activities include but are not limited to, task-based internet searches through a browser application; for example, online research pertaining to a topic. A user researching a topic such as “Paris” may search for various kinds of information related to “Paris,” such as hotels, museums, shows, and restaurants. When a user begins the search, the user may utilize one parent browsing window. As the user progresses in his or her search, the user may accumulate several browsing windows and tabs. One or more child windows or tabs may be opened from the same parent window, where the user initiated his or her search about “Paris.” Several parent windows, each having multiple associated child browsing windows, may be accumulated by a user during a research task.

According to an aspect of the disclosed technology, the browsing activities may need to occur within a predetermined period of time. For example, the browsing activities may need to have occurred within the same 24 hour period to be considered relevant to each other. Alternatively, time proximity may not need to factor into determining whether a certain browsing activities constitute a browsing sessions.

At block 204, the system identifies a theme for each browsing activity. For example, in the “Paris” example described above, the theme is “Paris.” A theme may be identified by analyzing content such as text, pictures, comments, as well as link structure, host name, URL, or other attributes of a browsing activity. A theme may be represented by key words, phrases, or other representations.

At block 206, the system determines whether at least two browsing activities have a common theme. To that end, the system may compare the identified theme of each browsing activity to the theme of other browsing activities to determine whether the browsing activities have a common theme. In the current “Paris” example, the system analyzes the browsing activities to determine whether at least two browsing activities are related to research about “Paris.” When a common theme is not found in at least two browsing activities, process 200 ends. When at least two browsing activities having a common theme are identified, the system groups the browsing activities into a browsing session, at block 208. While other browsing activities that are not related to the topic being researched by the user may also be concurrently active, such other browsing activities are not grouped into the browsing session when such activities do not share a common theme. For example, an email application may be running concurrently to the various browsing activities, but such application is not grouped into the “Paris” browsing session because it is not related to the identified common theme.

According to an aspect of the disclosed technology, the system may receive an indication from a user that one or more browsing activities constitute a browsing session. Furthermore, browsing activities may be associated with a particular user and a particular user account. Alternatively, browsing activities may be associated with a particular client device.

At block 210, the system identifies a browser state of the browsing session. The browser state may include such data items as the windows that are open, the tabs contained in the windows and a designation regarding which tab is active, scrolling position, window position, tab history, and HTML, for example. The browser state of a browsing session may include information regarding which users or accounts are currently active. At block 212 the system generates a record representing the browser state. The record may be a snapshot, for example, which is stored locally at a client device or at a remote server. A snapshot of a browser state may be created while the browser state is open. Alternatively, a stream of the user's browsing activity may be stored and snapshots may be built based on the content of the stream. The snapshots may also be named, manually by the user, or automatically, based on the content of the snapshot. Naming a snapshot may include associating an image such as a screenshot of the state, with the snapshot.

At block 214, the system identifies a current online activity. According to an aspect of the disclosed technology, current online activities occur subsequent to the browsing activities discussed with reference to block 202. In other words, browsing activities that make up a browsing session whose browser state is saved as a snapshot are historical as compared to the current online activities, which are in the present. A current online activity may include a new browser window where a new search is initiated. Receiving a search query may constitute identifying a current online activity. At block 216, the system identifies a theme of the current online activity and compares the identified theme of the current online activity to the common themes of the browsing sessions for which a snapshot representing a browser state has been generated. At block 208, the system determines whether the theme of the current online activity corresponds to a common theme of a browsing session.

When the theme of the current online activity does not correspond to a theme of a browsing session, the process 200 ends. However, when themes correspond, the system retrieves the record representing the browser state of a corresponding browsing session at block 220. The record representing the browser state may be associated with a user and a unique user profile, and may be provided to the particular user. The record may alternatively be associated with a particular client device, and thus the record may further be provided to the particular client device. The particular client device may further be associated with a user. Also, a notification or a suggestion may be sent to a user that a record representing a browser state of a browsing session is available. The retrieved record may be limited to a particular user, when multiple users or accounts were captured in a browsing session. At block 222, the record representing the browser state is provided for display to a user. To that end, the record may automatically be provided for display at a client device associated with the user.

When current online activity is a search query, the theme of the search query is identified, as discussed with reference to block 216. In such implementation, the record representing the browser state of a browsing session may be used as a search query result. To that end, once the search query is received and its theme is identified, the system may compare the theme of the received search query to the common theme of the browsing session, retrieve the record when the identified theme of the received search query corresponds to the common theme of the browsing session and cause the record to be used as a search query result for the received search query. The record may be used as the search query result for the received search query prior to causing the received search query to be executed. Alternatively, the record may be used as the search query result for the received search query instead of causing the received search query to be executed.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing display. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

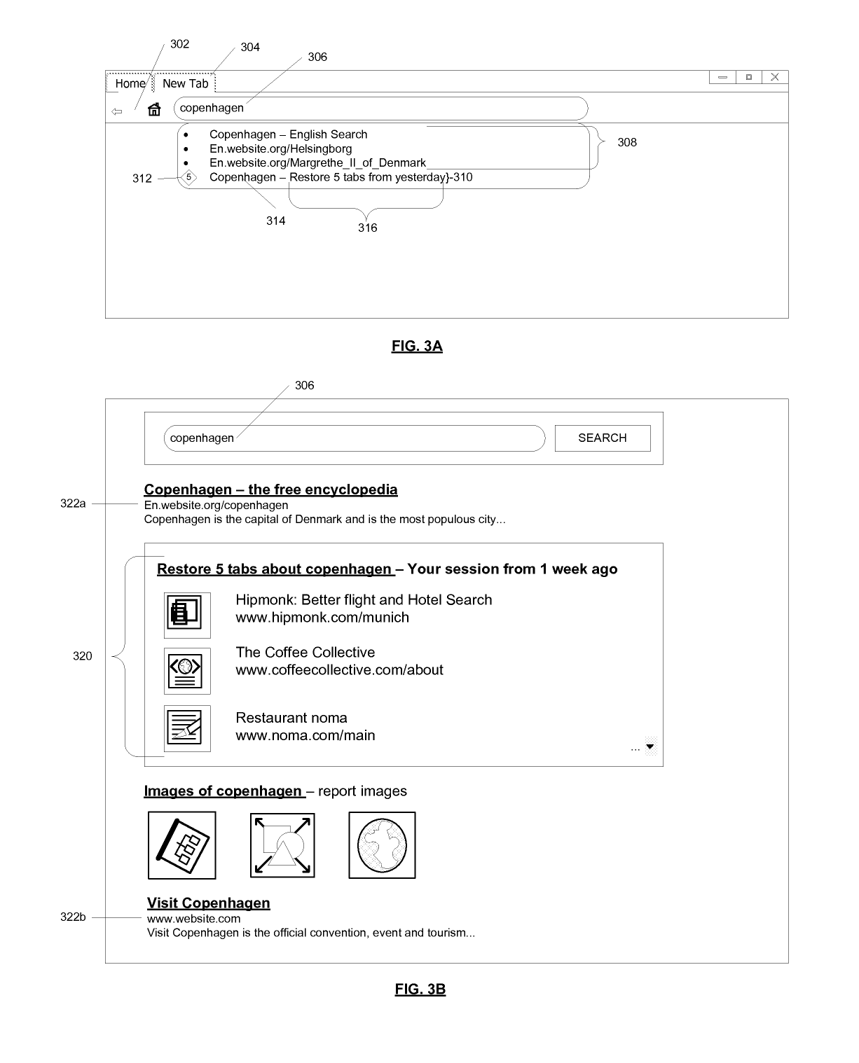

FIGS. 3A and 3B illustrate an example browser in which a browser state associated with a browsing session is recovered.

FIG. 3A depicts a new browser tab 304 in a web browser application 302 where a user has entered a search query 306 for “Copenhagen.” At 308, the web browser application 302 suggests similar or related search terms to the user The alternate search terms may be based on the user's prior research, terms that are likely to be relevant or interesting, corrected spelling of a search term entered by a user, or the like. At 310, the system provides the user with a search suggestion to “Restore 5 tabs from yesterday” to aid in his research about Copenhagen. As part of the search suggestion 310, the system provides a tabs count indicator 312, which tells the user that there are five tabs that relate to Copenhagen that can be restored. The search suggestion 310 also includes the name of the stored record, “Copenhagen,” 314, which stands for the theme of the stored record, and the suggestion narrative to “Restore 5 tabs from yesterday,” 316.

If the user selects the search suggestion 310 to “Restore 5 tabs from yesterday,” which relates to “Copenhagen,” the system provides the record representing the “5 tabs from yesterday” as a result for search query 306. The system may or may not cause the search query 306 to be executed by the application browser 302. That is, the system may provide the record representing the “5 tabs from yesterday” as the result for search query 306, instead of executing a new search. The user may have an option to then execute the search query 306 or to accept the record representing the “5 tabs from yesterday” as the result for search query 306. The record 306 includes browser state information for the browsing session about Copenhagen, as described above, with reference to FIG. 2.

Alternatively, the system may append the record representing the “5 tabs from yesterday” or merge the record with new search results obtained by the system when browser application 302 executes the search query 306, as illustrated in FIG. 3B. Specifically, FIG. 3B illustrates an implementation where the record representing the “5 tabs from yesterday,” 320 is appended to or merged with the search results 322 for search query 306. As stated previously, the record 320 includes browser state information for the browsing session about Copenhagen.

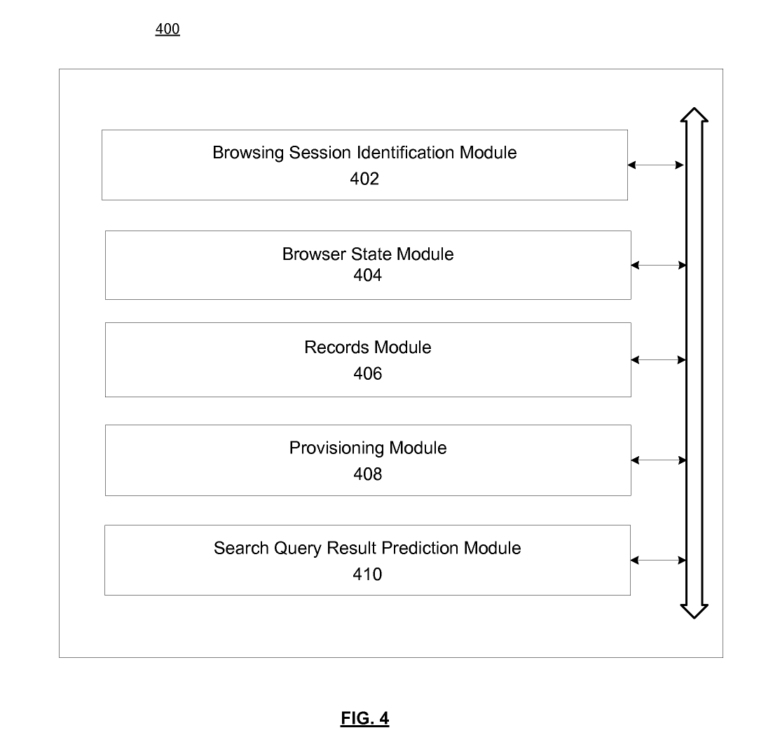

FIG. 4 illustrates an example of system 400 for recovering a browser state, in accordance with various aspects of the subject technology. System 400 comprises a browsing session identification module 402, a browser state module 404, a records module 406, and a provisioning module 408. The system may also include a search query result prediction module 410.

The browsing session identification module 402 is configured to identify a browsing session from a plurality of browsing activities, wherein the browsing session comprises browsing activities having a common theme. The browser state module 404 is configured to identify a browser state of the identified browsing session. The records module 406 is configured to generate a record representing the browser state of the browsing session. The provisioning module 408 is configured to retrieve the record when a current online activity has a theme that corresponds to the common theme of the browsing session.

The browsing session identification module 402 may further be configured to identify a plurality of browsing activities, identify a theme for each identified browsing activity, determine a theme that is common to at least two of the identified browsing activities and group browsing activities that correspond to the determined common theme into a browsing session. The browsing session identification module 402 may still further be configured to receive a user indication that one or more browsing activities constitute the browsing session.

The provisioning module 408 may further be configured to identify a current online activity, identify a theme for the current online activity, compare the identified theme of the current online activity to the common theme of the browsing session, retrieve the record when the identified theme of the current online activity corresponds to the common theme of the browsing session and provide the record to a user associated with the current online activity.

The system 400 may also include a search query result prediction module 410 configured to receive a search query at a client device, identify the theme of the received search query, compare the identified theme of the received search query to the common theme of the browsing session and provide the record as a search query result when the identified theme of the current online activity corresponds to the common theme of the browsing session.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

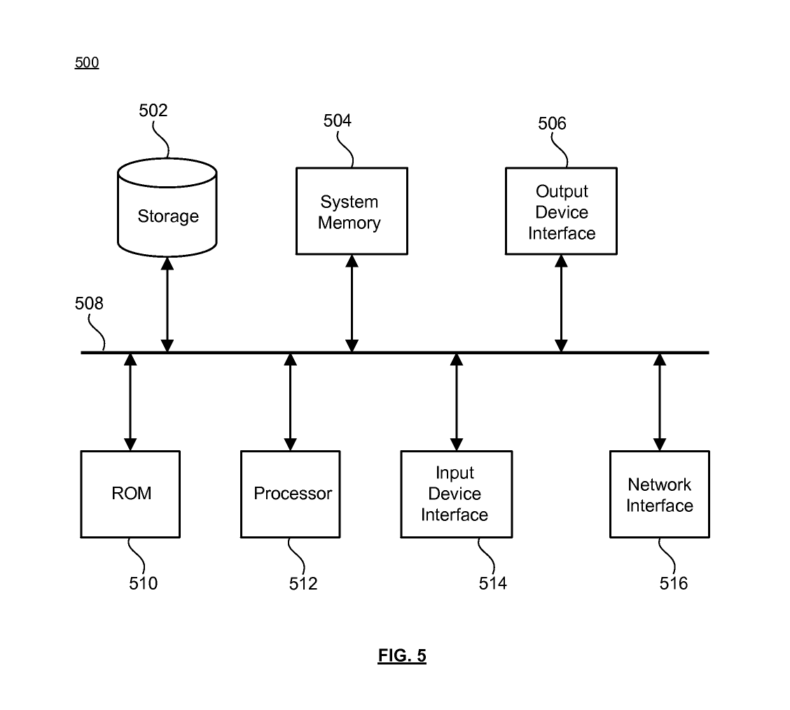

FIG. 5 conceptually illustrates an electronic system with which some aspects of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as televisions or other displays with one or more processors coupled thereto or embedded therein, or other appropriate computing devices that can be used for running an application. Some implementations include devices such as a touch screen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method comprising:
identifying one or more browsing sessions from a plurality of browsing activities, each of the one or more browsing sessions comprising browsing activities having a common theme;
identifying a browser state of each of the one or more browsing sessions;
generating a record representing the browser state of each of the one or more browsing sessions, wherein the record is associated with the common theme of the browsing activities comprising each of the one or more browsing sessions;
storing the generated record representing the browser state of each of the one or more browsing sessions;
identifying a current search query term;
identifying a theme of the current search query term;
comparing the identified theme of the current search query term to the common theme of the at least one of the one or more browsing sessions;
retrieving the stored record when the identified theme of the current search query term corresponds to the common theme of at least one of the one or more browsing sessions; and
providing the retrieved record as a search suggestion for the current search query term without executing a search query based on the current search query term.

2. The computer-implemented method of claim 1, further comprising:
providing the retrieved record to a user associated with the current online activity.

3. The computer-implemented method of claim 1, further comprising:
providing the retrieved record to a client device associated with the current online activity.

4-6. (canceled)

7. The computer-implemented method of claim 1, further comprising:
causing the retrieved record to be used as a portion of a search query result after executing the search query based on the current search query term.

8. The computer-implemented method of claim 1, further comprising:
receiving a selection of the search suggestion; and
causing the retrieved record to be used as a search query result instead of executing the search query based on the current search query term.

9. The computer-implemented method of claim 1, wherein identifying the one or more browsing sessions from the plurality of browsing activities comprises:
identifying the plurality of browsing activities;
identifying a theme for each identified browsing activity;
determining a theme that is common to at least two of the identified browsing activities; and
grouping browsing activities that correspond to the determined common theme into a browsing session.

10. The computer-implemented method of claim 9, wherein the browsing activities occur within a predetermined period of time.

11. The computer-implemented method of claim 1, wherein identifying the one or more browsing sessions from the plurality of browsing activities comprises:
receiving a user indication that one or more browsing activities constitute the one or more browsing sessions.

12. The computer-implemented method of claim 1, wherein storing the generated record representing the browser state of each of the one or more browsing sessions comprises storing the generated record at a remote server.

13. A system for recovering a browser state, the system comprising:
a browsing session identification module configured to identify a browsing session from a plurality of browsing activities, wherein the browsing session comprises browsing activities having a common theme;
a browser state module configured to identify a browser state of the identified browsing session;
a records module configured to generate a record representing the browser state of the browsing session, wherein the record is associated with the common theme of the browsing activities comprising the browsing session; and
a provisioning module configured to:
identify a current search query term;
identify a theme of the current search query term;
compare the identified theme of the current search query term to the common theme of the browsing session;
retrieve the generated record when the identified theme of the current search query term corresponds to the common theme of the browsing session^{.} and
providing the retrieved record as a search suggestion for the current search query term without executing a search query based on the current search query term.

14. The system of claim 13, wherein the browsing session identification module is further configured to:
identify a plurality of browsing activities;
identify a theme for each identified browsing activity;
determine a theme that is common to at least two of the identified browsing activities; and
group browsing activities that correspond to the determined common theme into a browsing session.

15. The system of claim 13, wherein the browsing session identification module is further configured to:
receive a user indication that one or more browsing activities constitute the browsing session.

16. (canceled)

17. The system of claim 13, wherein the provisioning module is further configured to:
provide the generated record to a user associated with the current online activity search query term.

18. The system of claim 13, further comprising a search query result prediction module configured to:
receive a search query at a client device;
identify the theme of the received search query;
compare the identified theme of the received search query to the common theme of the browsing session;
retrieve the generated record when the identified theme of the received search query corresponds to the common theme of the browsing session; and
cause the generated record to be used as a search query result for the received search query.

19. A non-transitory machine-readable medium comprising instructions stored therein, which when executed by one or more processors, cause the processors to perform operations comprising:
identifying a plurality of browsing activities;
identifying a theme for each identified browsing activity;
determining a theme that is common to at least two of the identified browsing activities;
grouping the at least two browsing activities having the common theme into a browsing session;
identifying a browser state of the browsing session;
generating a record representing the browser state of the browsing session, wherein the record is associated with the common theme of the browsing activities comprising the browsing session;
storing the generated record representing the browser state of the browsing session;
identifying a current online activity, wherein the current online activity occurs subsequent to the plurality of browsing activities comprising the browsing session based on which the record representing the browser state of the browsing session is generated, the identifying the current online activity comprising:
identifying a current search query term;
identifying a theme for the current search query term;
comparing the identified theme of the current search query term to the common theme of the browsing session;
retrieving the stored record when the identified theme of the current search query term corresponds to the common theme of the browsing session; and
providing the retrieved record, to a user associated with a current online activity, as a search suggestion for the current search query term without executing a search query based on the current search query term.

20. (canceled)
